(19) United States
(12) Patent Application Publication
(10) Pub. No.: US 2005/0155010 A1
(43) Pub. Date: Jul. 14, 2005

(54) Method, system and memory for replacing a module

(76) Inventor: M. George George, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/753,072

(22) Filed: Jan. 8, 2004

(51) Int. Cl. G06F 9/44

(52) U.S. Cl. 717/100

(57) ABSTRACT

An implementation module is replaced without affecting system continuity by creating, within an interface module, a plurality of proxy functions corresponding to a plurality of proxy functions within the implementation module. Entries into and exits out of the implementation module are tracked by the system. When the implementation module is to be replaced, the interface module blocks entry by the system into the implementation module. When the number of entries corresponds to the number of exits, the implementation module is replaced. Some global variables of the implementation module are stored in the interface module.

### FIELD OF INVENTION

The present invention relates to a method, system and memory for replacing a module. More particularly, but not exclusively, the present invention relates to a method, system and software for online replacement of an implementation module without affecting application or system continuity.

### BACKGROUND OF THE INVENTION

Software components for applications and operating systems often require updating or “patching” after they have been deployed.

Some applications and operating systems are mission-critical. This means that they must be available, or online, for use at all times. In such cases it can be difficult to replace the software components when it becomes necessary.

One major difficulty with “online” replacement of software components is that state information—global variables—within the component needs to be preserved when the component is replaced by a new component if application/system continuity is desired.

Prior solutions to preserve state information during module replacement require either (1) saving and restoring state; or (2) compiler support. The former is error prone as significant programming is required to save and restore each variable. The latter is also error prone as adding a variable in the module can result in state information becoming stale. With prior solutions module state has to be reset or saved, and restored to replace the module. This will impact application availability as state information becomes unavailable during this operation. Additional support is required when modules for multi-threaded applications/systems are replaced to ensure that all threads of the application/system do not call the module being replaced.

The following patent covers a method for updating software components: U.S. Pat. No. 6,154,878: System and method for on-line replacement of software.

The disadvantages of U.S. Pat. No. 6,154,878 are:
a. The method is only applicable to a shared library and does support all software modules such as kernel modules.
b. State information is permitted to be kept in the implementation module which requires either:
   a. saving and restoring of state information which makes the solution complex and error prone; or
   b. compiler support to preserve state information across unloading and loading of new module. This imposes the severe restriction that no change of the data definition of the older module is allowed in addition to requiring modification to the loader to preserve data across unload and load.

It is an object of the present invention to overcome the disadvantages of the prior art, or to at least provide the public with a useful choice.

### SUMMARY OF THE INVENTION

According to a first aspect of the invention there is provided a method of replacing an implementation module used by a system, including the steps of:
i) creating an interface module;
ii) creating a plurality of proxy functions within the interface module corresponding to a plurality of functions within the implementation module;
iii) tracking entries into and exits out of the implementation module by the system;
iv) when the implementation module is to be replaced:
   a. the interface module blocking entry by the system into the implementation module; and
   b. when the number of entries correspond to the number of exits, replacing the implementation module;
wherein the system uses the functions within the implementation module by calling the proxy functions and wherein some of the global variables of the implementation module are stored within the interface module.

Preferably, the implementation module's state information is not stored within the implementation module.

The interface module may block entry by the system into the implementation module only when it is safe to do so.

The system may be an operating system or an application.

Preferably, the interface module performs step (iii). The tracking may be performed by a reference counter or/and by using reference flags.

Where the system is an application, the interface module may be statically or dynamically linked to the application.

The system may include a plurality of threads, some of which may utilize the implementation module.

Some state information may be stored on a heap.

Preferably, there are no global variables stored within the implementation module.

The implementation module may be replaced with an updated or corrected version.

Preferably, each of the proxy functions has the original calling name of the implementation functions, and the implementations functions have been renamed.

According to a further aspect of the invention there is provided a method of converting an implementation module, comprised of a plurality of functions, to a replaceable implementation module, including the steps of:
i) creating an interface module;
ii) creating a plurality of proxy functions, corresponding to the implementation functions, within the interface module wherein the calling name of each proxy function is the calling name of the corresponding implementation function; and
iii) moving some global variables from the implementation module to the interface module;
wherein the interface module is arranged for tracking the number of implementation functions in use, blocking calls to use the implementation functions when the module is to be replaced, and replace the module when no implementation functions are in use.

The method preferably includes renaming the calling names of the implementation functions.

According to a further aspect of the invention there is provided an interface module for an implementation module, including:
i) a plurality of proxy functions corresponding to a plurality of functions within the implementation module;
ii) a tracking mechanism which records the number of implementation functions in use;
iii) a blocking mechanism which blocks calls to the implementation functions when the module is to be replaced;
iv) a replacement mechanism which replaces the implementation module when no implementation functions are in use; and
v) global variables extracted from the implementation module.

According to a further aspect of the invention there is provided a system for replacing an implementation module, including:
i) a memory which stores an implementation module comprised of a plurality of functions;
ii) a memory which stores an interface module comprised of global variables extracted from the implementation module and a plurality of proxy functions each arranged for executing a corresponding implementation function; and
iii) a processor arranged for relaying calls to use an implementation function to a corresponding proxy function, tracking the use of the implementation functions, blocking calls to the implementation functions when the implementation module is to be replaced, and replacing the implementation module when no implementation functions are in use.

An added aspect of the invention relates to a method of and system for replacing an implementation module used by a system. The method is performed with the aid of an interface module that is included in the system. The method includes the steps of: creating within the interface module a plurality of functions corresponding to a plurality of functions within the implementation module; tracking entries into and exits out of the implementation module by the system; when the implementation module is to be replaced: (a) blocking entry by the system into the implementation module by using the interface module; and (b) replacing the implementation module when the number of entries correspond to the number of exits; causing the system to use the functions within the implementation module by calling the proxy functions; and storing within the interface module some of the of the global variables of the implementation module.

An additional aspect of the invention relates to a method of and system for converting an implementation module, comprised of a plurality of functions, to a replaceable implementation module, the method being performed with the aid of an interface module that is included in the system. The method includes the steps of: creating, within the interface module, a plurality of proxy functions, corresponding to the implementation functions wherein the calling name of each proxy function is the calling name of the corresponding implementation function; moving some global variables from the implementation module to the interface module; tracking with the interface module the number of implementation functions in use; blocking, with the interface module, calls to use the implementation functions when the implementation module is to be replaced, and replacing, with the interface module, the implementation module when no implementation functions are in use.

### BRIEF DESCRIPTION OF THE DRAWINGS

Embodiments of the invention will now be described, by way of example only, with reference to the accompanying drawings in which:

FIG. 1: is a diagram of how the method enables use of an implementation module through an interface module.

FIG. 2: is a diagram of how the method blocks further calls to use functions within the implementation module when module replacement is to occur.

FIG. 3: is a diagram of how the method replaces the module.

FIG. 4: is a diagram illustrating of how the method converts an implementation module into a replaceable implementation module.

### DETAILED DESCRIPTION OF PREFERRED EMBODIMENTS

In a preferred embodiment a module replacement can be done without the requirement to restore state and ensuring application/system continuity. Applications and systems can continue the operations they were performing as soon as the module is replaced.

In a preferred embodiment all the module state information in an interface module and the heap is retained. Only temporary module state information in the stack or temporary module state that is valid only when the implementation module is active (active corresponding a state where an implementation module function is called by any thread and call has not returned) is defined in the implementation module. All remaining state information is defined in global variables in the interface module and the heap. Since there is no state in the implementation module when the implementation module is not active, there is no need to restore state when the implementation module is replaced.

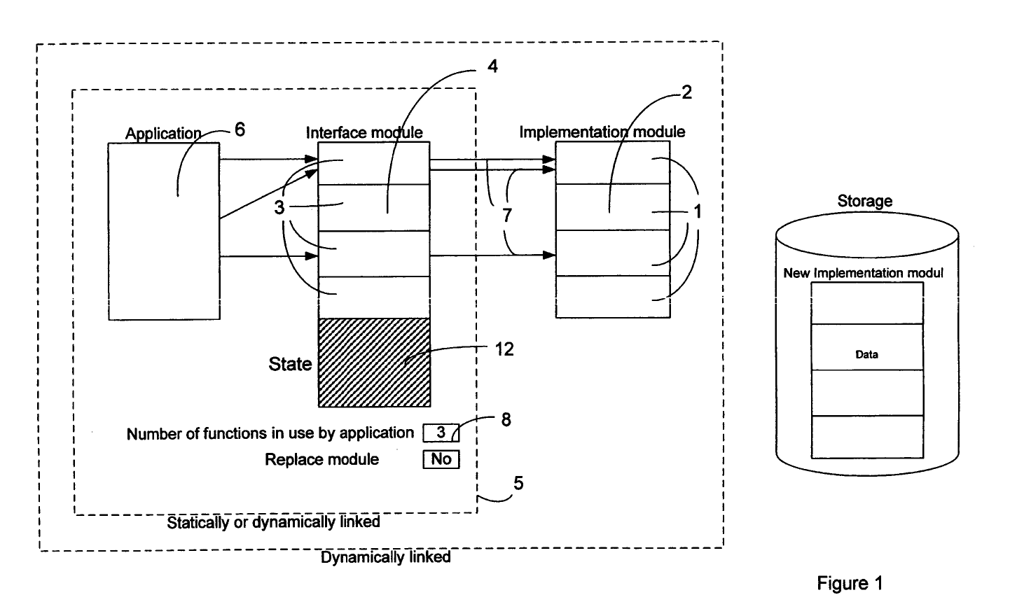

A method of and apparatus for preserving application availability during module replacement is now described with reference to FIGS. 1 to 3.

It will be appreciated that method can be used to ensure operating system availability, during OS module replacement, with appropriate modifications.

The first step is that all entry functions 1 of the module 2 that can be replaced should be accessed through stubs 3 (proxy functions) in interface module 4 as explained in U.S. Pat. No. 6,154,878. The interface module 4 may be statically or dynamically linked 5 to the application 6.

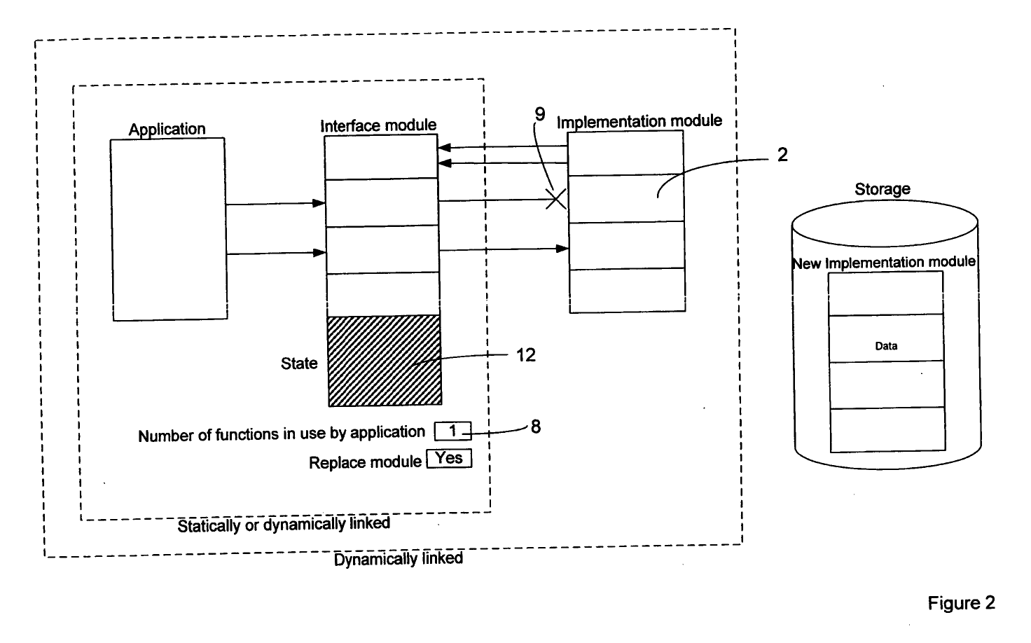

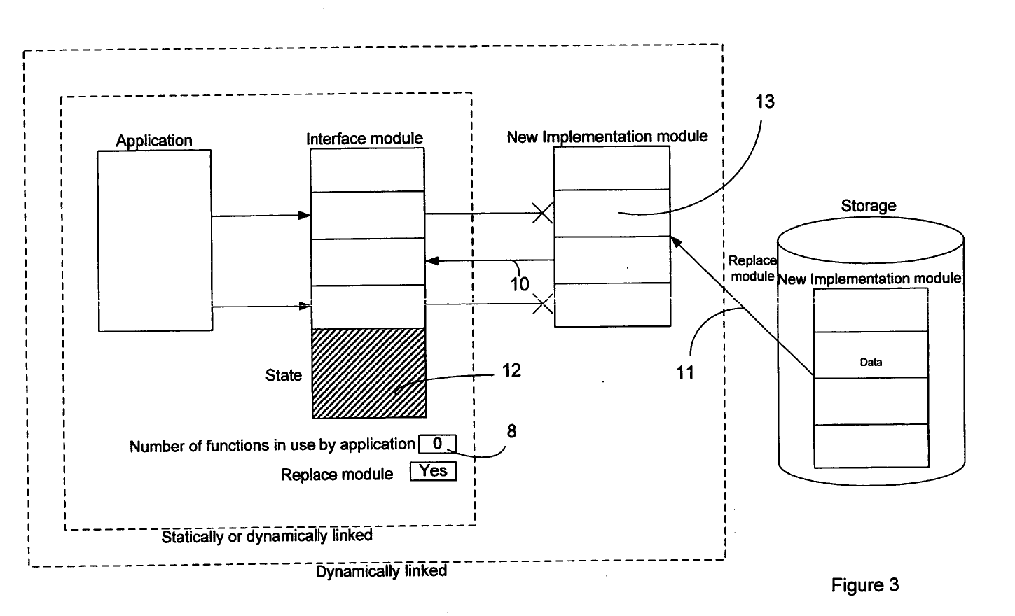

The second step is that all entries 7 into or out of the implementation module 2 are tracked using reference counts 8 and/or other tracking mechanisms, such as reference flags. The interface module 4 will block calls 9 (see FIG. 2) into implementation module 2 when it is safe to do so and, after all previous calls to implementation module return 10 (see FIG. 3), replace the module 11.

In the third step module state 12 has been preserved in the interface module and in the heap. Therefore the module state is preserved across replacement and the application 6 can continue accessing the module 13 after replacement and continue execution.

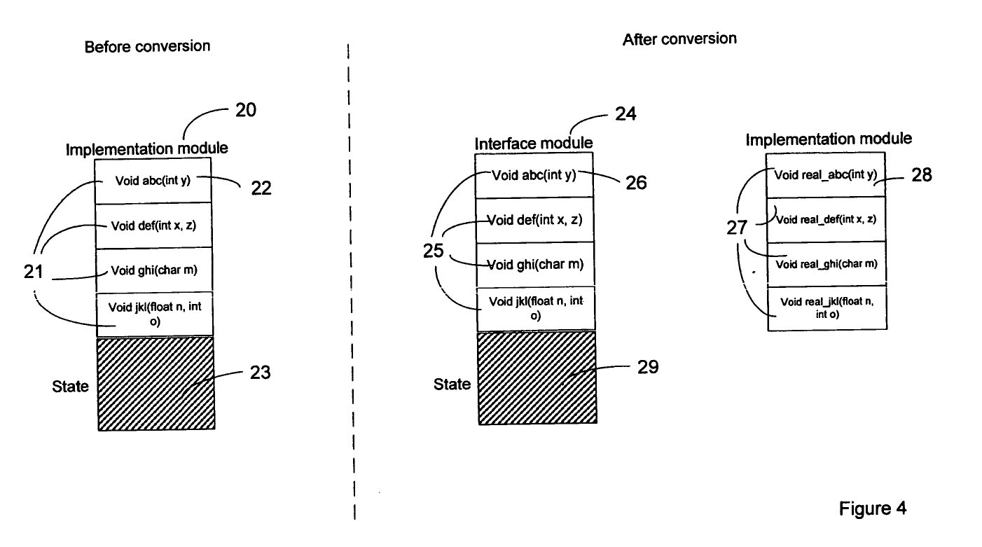

An example, which illustrates how the implementation is converted into a replaceable implementation module, will now be described with reference to FIG. 4. In this example, the number of calls to the replaceable module is tracked using a reference counter.

The example considers a module “X.c” 20. The module X.c is such that its functions do not call functions in another module. The module “X.c” 20 is made of functions 21 in a “C language file” “X.c”. Consider a function “void abc(int y)” 22 which is part of the module “X.c” 20. In order to replace module “X.c” preserving state information 23, the following steps are performed:
1. Create an interface module 24, “Interface_X.c”, which may be statically or dynamically linked.
2. For each function 21 in module “X.c”, create an interface (stub) function 25 with same name and parameters in “Interface_X.c”. So function “void abc(int y)” 26 is added into “Interface_X.c” 24.
3. Rename the functions 27 in module “X.c”. “Void abc(int y)” is renamed to “void real_abc(int y)” 28. Since the function is renamed, all calls to function “void abc(int y)” will now go to the interface function “void abc(int y)” 26 in “Interface_X.c” 24.
4. Move all variables that hold state information in “X.c” into “Interface-X.c” 29.
5. Number of function calls to “X.c” is tracked within the pseudo-code below using variable “X_reference_count”. Pseudo-code, similar to that for interface function “void abc(int y)” shown below, should be added for each interface function in “Interface_X.c” so that “X_reference_count” gives the number of active calls to module “X.c” (that are currently active). Module “X.c” can be replaced when the value of “X_reference_count” is zero.

Pseudo-code for the stub function “void abc(int y)” within the interface module is given below:

File “Interface_X.c”::
/* ALL VARIABLES FROM X.c HOLDING STATE INFORMATION ARE DEFINED */
. . .
/* ALL VARIABLES FROM X.c DEFINED ABOVE */
char X_replace_module_flag = 0; /* THE FLAG IS SET WHEN MODULE NEEDS TO
BE REPLACED */
long X_reference_count=0; /* GIVES THE NUMBER OF CALLS CURRENTLY MADE
INTO MODULE “X.c” THAT HAVE NOT RETURNED */
void (*real_abc) (int y);
void abc(int y)
{

do {

lock( );
if (X_replace_module_flag IS SET) {

```
/*
  * REPLACE “X.c” IF POSSIBLE
  */
if (X_reference_count > 0) {
```

```
/*
  * THERE ARE ACTIVE CALLS TO FUNCTIONS IN “X.c”
  * GO TO SLEEP
  */
unlock( );
sleep for “Z” milli/microseconds;
continue; // REPEAT THE do LOOP
```

}
else {

```
/*
  * THERE ARE NO ACTIVE CALLS TO X.c
  * SO REPLACE X.c
  */
unload module “X.c”;
load new version of module “X.c”;
/*
Update pointers to real functions;
*/
real_abc = GET-NEW-POINTER(new_module_handle,
“real_abc”);
X_replace_module_flag = 0; /* INDICATE THAT
MODULE REPLACEMENT IS COMPLETE */
unlock ( );
continue; // REPEAT THE do LOOP
```

}

}
else {

/* INDICATE THAT A FUNCTION IN X.c IS CALLED ONCE MORE
*/
X_reference_count++;
unlock ( );
break; // COME OUT OF THE LOOP

}

}
real_abc(y);/* THE ACTUAL FUNCTION IN “X.c” IS CALLED HERE */
lock( );
/* INDICATE THAT A CALL TO A FUNCTION IN X.c HAS RETURNED */
X_reference_count--;
if ((X_replace_module_flag IS SET) AND (X_reference_count IS 0) {

```
/*
  * REPLACE X.c
  */
unload module X;
load new version of X;
X_replace_module_flag = 0; /* INDICATE THAT MODULE
REPLACEMENT IS COMPLETE */
```

}
unlock ( );

}

6. The pseudo-code given in step (5) for interface functions is effective as long as the corresponding functions in “X.c” do not sleep or wait for events indefinitely. If the functions go to sleep or wait indefinitely, module specific code is needed to ensure the functions are woken up or the wait is broken. Alternatively, “X.c” could be rewritten to move sleep/wait out of “X.c”. Such changes are module specific and are outside the scope of this invention.

The steps can be performed by a programmer utilizing standard programming processes, or they could be performed automatically using a script.

If the application is multi-threaded and if the threads call functions from the module being replaced, the threads will block until replacement is complete. If the application is written in such a way that not all of its threads access functions of modules that can be replaced, remaining threads will continue to run even during module replacement. In this way application continuity is ensured even while modules of the application are being replaced.

Similarly when an Operating System module is replaced, only threads that call the module will block and the system can continue to be available even during OS module replacement.

Current technologies do not provide application/system availability during module replacements. The advantage of the present invention is that it provides contiguous application/system availability even when a component module of the application/system is replaced. For example, an Airline Reservation system could be enhanced to add security features while bookings are ongoing. With the present invention, users of the application may only see small additional delay while replacement is happening, but no disruption.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

1. A method of replacing an implementation module used by a system, including the steps of:
i) creating an interface module;
ii) creating a plurality of proxy functions within the interface module corresponding to a plurality of functions within the implementation module;
iii) tracking entries into and exits out of the implementation module by the system;
iv) when the implementation module is to be replaced:
a. the interface module blocking entry by the system into the implementation module; and
b. when the number of entries correspond to the number of exits, replacing the implementation module;
wherein the system uses the functions within the implementation module by calling the proxy functions and wherein some of the global variables of the implementation module are stored within the interface module.

2. A method as claimed in claim 1 wherein no state information of the implementation module is stored within the implementation module.

3. A method as claimed in claim 1 wherein the interface module blocks entry by the system into the implementation module only when it is safe to do so.

4. A method as claimed in claim 1 wherein the system is an operating system.

5. A method as claimed in claim 1 wherein the system is an application.

6. A method as claimed in claim 1 wherein the interface module performs step (iii).

7. A method as claimed in claim 6 wherein the tracking is performed using a reference counter.

8. A method as claimed in claim 6 wherein the tracking is performed using reference flags.

9. A method as claimed in claim 6 wherein the tracking is performed using reference counts and reference flags.

10. A method as claimed in claim 5 wherein the interface module is statically linked to the application.

11. A method as claimed in claim 5 wherein the interface module is dynamically linked to the application.

12. A method as claimed in claim 1 wherein the system includes a plurality of threads and at least some of the threads use the implementation module.

13. A method as claimed in claim 2 wherein some of the state information of the implementation module is stored on a heap.

14. A method as claimed in claim 1 wherein the implementation module is replaced with an updated version.

15. A method as claimed in claim 1 wherein the implementation module is replaced with a corrected version.

16. A method as claimed in claim 1 wherein each proxy function has the calling name of the corresponding function and the corresponding function is renamed.

17. A method of converting an implementation module, comprised of a plurality of functions, to a replaceable implementation module, including the steps of:
i) creating an interface module;
ii) creating a plurality of proxy functions, corresponding to the implementation functions, within the interface module wherein the calling name of each proxy function is the calling name of the corresponding implementation function; and
iii) moving some global variables from the implementation module to the interface module;
wherein the interface module is arranged for tracking the number of implementation functions in use, blocking calls to use the implementation functions when the implementation module is to be replaced, and replacing the implementation module when no implementation functions are in use.

18. A method as claimed in claim 17 including the step of:
renaming the calling names of the implementation functions.

19. A method as claimed in claim 17 further including moving some global variables from the implementation module to another module.

20. A method as claimed in claim 17 wherein no global variables which hold state information are left within the implementation module

21. A method as claimed in claim 17 wherein the interface module blocks calls to use the implementation functions only when it is safe to do so.

22. An interface module for an implementation module, including:
i) a plurality of proxy functions corresponding to a plurality of functions within the implementation module;
ii) a tracking mechanism for recording the number of implementation functions in use;
iii) a blocking mechanism for blocking calls to the implementation functions when the module is to be replaced;
iv) a replacement mechanism for replacing the implementation module when no functions are in use; and
v) global variables for extraction from the implementation module.

23. A system for replacing an implementation module, including:
i) a memory which stores an implementation module comprised of a plurality of functions;
ii) a memory which stores an interface module comprised of global variables extracted from the implementation module and a plurality of proxy functions each arranged for executing a corresponding implementation function; and
iii) a processor arranged for (a) relaying calls to use an implementation function to a corresponding proxy function, (b) tracking the use of the implementation functions, (c) blocking calls to the implementation functions when the implementation module is to be replaced, and (d) replacing the implementation module when no implementation functions are in use.

24. A method of replacing an implementation module used by a system, the method being performed with the aid of an interface module, and the method including the steps of: creating within the interface module a plurality of functions corresponding to a plurality of functions within the implementation module; tracking entries into and exits out of the implementation module by the system; when the implementation module is to be replaced: (a) blocking entry by the system into the implementation module by using the interface module and (b) replacing the implementation module when the number of entries correspond to the number of exits; causing the system to use the functions within the implementation module by calling the proxy functions; and storing within the interface module some of the of the global variables of the implementation module.

25. A method of converting an implementation module, comprised of a plurality of functions, to a replaceable implementation module, the method being performed with the aid of an interface module; the method including the steps of: creating within the interface module, a plurality of proxy functions corresponding to the implementation functions wherein the calling name of each proxy function is the calling name of the corresponding implementation function; moving some global variables from the implementation module to the interface module; tracking, with the interface module, the number of implementation functions in use, blocking, with the interface module, calls to use the implementation functions when the implementation module is to be replaced, and replacing, with the interface module, the implementation module when no implementation functions are in use.

26. A system for performing the method of claim 1.

27. A system for performing the method of claim 17.

28. A system for performing the method of claim 24.

29. A system for performing the method of claim 25.

30. A memory storing a program for causing a computer to perform the method of claim 1.

31. A memory storing a program for causing a computer to perform the method of claim 17.

32. A memory storing a program for causing a computer to perform the method of claim 24.

33. A memory storing a program for causing a computer to perform the method of claim 25.

34. Storage media storing a program for causing a computer to perform the method of claim 1.

35. Storage media storing a program for causing a computer to perform the method of claim 17.

36. Storage media storing a program for causing a computer to perform the method of claim 24.

37. Storage media storing a program for causing a computer to perform the method of claim for causing the memory of claim 25.

38. A binary file including an interface module and a replaceable implementation module created according to the method of claim 17.

39. A binary file including an interface module as claimed in claim 22.

40. A method comprising the step of supplying a computer with a program for causing the computer to perform the method of claim 1.

41. A method comprising the step of supplying a computer with a program for causing the computer to perform the method of claim 17.

42. A method comprising the step of supplying a computer with a program for causing the computer to perform the method of claim 24.

43. A method comprising the step of supplying a computer with a program for causing the computer to perform the method of claim 25.
